(19) United States
(12) Patent Application Publication
(10) Pub. No.: US 2019/0002213 A1
(43) Pub. Date: Jan. 3, 2019

(54) PROCESS FOR CONTINUOUSLY GALVANIZING ELONGATED ARTICLES

(71) Applicant: AZZ, INC., FORT WORTH, TX (US)

(72) Inventors: Roger Decoster, Port of Catoosa, OK (US); Sam Hartley, Port of Catoosa, OK (US); John Lincoln, Fort Worth, TX (US)

(21) Appl. No.: 16/022,156

(22) Filed: Jun. 28, 2018

Related U.S. Application Data
(60) Provisional application No. 62/526,483, filed on Jun. 29, 2017.

(51) Int. Cl. B65G 49/04; B05C 3/10; C23C 2/18; C23C 2/36

(52) U.S. Cl. CPC B65G 49/0413; C23C 2/36; C23C 2/18; B05C 3/10

(57) ABSTRACT

A method of continuously galvanizing elongated articles conveys a plurality of the elongated articles side by side in a group through several stages. One stage is a cleaning stage that uses cleaning media to remove contaminants. Another stage sprays flux on the elongated articles and removes excess flux therefrom. The group of elongated articles is then heated. A kettle heats a galvanizing bath comprising zinc and aluminum. The galvanizing bath is circulated into the bottom of a trough and the group of elongated articles is conveyed through the galvanizing bath in the trough. The group is then cooled.

### FIELD OF THE INVENTION

The present invention relates to a continuous process for galvanizing elongated articles, such as reinforcing bars, angles, t-posts, and sign posts.

### BACKGROUND OF THE INVENTION

Elongated articles may be used in applications that either call for, or benefit from, the articles being galvanized. For example, one type of elongated article is a reinforcing bar, or rebar. Other types of elongated articles include rods, round stock, T-posts, angles, sign posts, etc. The elongated articles are made of steel.

Reinforcing bars, or rebar, are steel bars commonly used in many concrete applications. While the concrete provides compressive strength, it lacks tensile strength. Rebar embedded in the concrete provides tensile strength. For example, when laying a paved road, a grid of rebar is located above the road grade. Concrete is poured onto the grade to encompass the grid of rebar. Once cured, the combination of the concrete and the embedded rebar is quite strong under both compressive and tensile loads.

Rebar is typically made from carbon steel and commonly has ribbing along its length, which increases contact with the concrete. For cost reasons, rebar is typically made of unfinished steel and is therefore subject to corrosion. In fact, it is common to buy rebar that is already rusting. Untreated rebar is often referred to in the industry as black rebar.

In many applications, the concrete cracks over time and water and salts further corrode the rebar. Such corrosion reduces the useful life of the concrete structure. In the prior art, applications requiring corrosion-resistant rebar use epoxy coated rebar. With epoxy coated rebar, the rebar is heated and the epoxy coating is sprayed on and allowed to cure. Epoxy coated rebar is more expensive than untreated rebar. In addition, epoxy coated rebar must be handled carefully so as not to damage the coating. Furthermore, exposure to ultraviolet (UV) light in sunlight can damage the epoxy coating. Most rebar applications are outside, so the epoxy covered rebar is covered until used.

Another type of corrosion resistant rebar is made from stainless steel. However, stainless steel rebar is usually many times more expensive than untreated rebar or epoxy coated rebar. Stainless steel rebar cannot be mixed with the less expensive untreated rebar due to corrosion concerns.

Still another type of corrosion resistant rebar is galvanized rebar. In galvanizing, a steel part is dipped into a bath of molten metal. The bath is primarily zinc with other additives that depend on the particular application. Once galvanized, the steel part resists corrosion. The price of galvanized rebar is higher than epoxy coated rebar. Also, some types of galvanized rebar may be subject to damage when the rebar is bent or curved; the galvanized coating may crack and fall off due to the bending.

Treating rebar to prevent corrosion is difficult as it must be done inexpensively. Many projects, such as roads, use large quantities of rebar and cannot afford treated rebar.

In the prior art, steel articles, such as wire, can undergo a continuous, rather than a batch, galvanizing process. In a batch galvanizing process, the pieces to be galvanized are dipped into a galvanizing kettle. In contrast to a batch process, in a continuous process, the pieces are conveyed or run through a galvanizing stage that sprays galvanizing metals onto the pieces. One problem that arises is the formation of dross. Dross utilizes the zinc in the galvanizing material and produces waste. The dross must be removed from the galvanizing stage, resulting in downtime.

Thus, there is a need for treating rebar, and other types of products, for protection against corrosion, which treatment is low in cost and that preserves the coating even when the articles are bent. There is also a need to minimize the formation of dross in the galvanizing metals.

### SUMMARY OF THE INVENTION

A method of continuously galvanizing elongated articles is provided. A plurality of the elongated articles is conveyed side by side in a group through a cleaning stage to remove contaminants and the elongated articles are blasted with cleaning media. The group of elongated articles is conveyed through a flux stage and flux is sprayed on the elongated articles. Excess flux is removed from the group of elongated articles, which are then heated. A kettle is provided with a galvanizing bath comprising zinc and aluminum, the aluminum comprising 0.1-1.0% by weight and the galvanizing bath in the kettle is heated. The galvanizing bath from the kettle is circulated into a bottom of a trough. The group of heated elongated articles is conveyed through the galvanizing bath in the trough and excess galvanizing material is removed from the group of elongated articles. The group of galvanized elongated articles is cooled.

In accordance with one aspect, the steps of conveying the group of elongated articles through the cleaning stage, the flux stage and the galvanizing bath further comprises the steps of using grooved rollers to maintain a fixed spacing between the side by side elongated articles.

In accordance with another aspect, the step of blasting the elongated articles with cleaning media further comprises the steps of using a first size media and a second size media, the first size media being larger than the second size media.

In accordance with another aspect, the step of blasting comprises a first blasting with the first size media, followed by a second blasting with the second size media.

In accordance with another aspect, the steps of conveying the group of elongated articles through the cleaning stage, the flux stage and the galvanizing bath further comprises the steps of maintaining a constant speed of the group of elongated articles.

In accordance with another aspect, the elongated articles comprise sticks of reinforcing bar.

In accordance with another aspect, the group of reinforcing bars is conveyed at speeds of 20-50 feet per minute.

In accordance with another aspect, the group of reinforcing bars is conveyed at speeds of 35-50 feet per minute.

In accordance with another aspect, the step of circulating the galvanizing bath from the kettle into a bottom of the trough further comprises the step of circulating the galvanizing bath into a sump of the trough.

In accordance with another aspect, further comprising the step of providing a nitrogen atmosphere around the trough.

In accordance with another aspect, further comprising the step of controlling the movement of groups of the elongated articles into a bundling area.

### BRIEF DESCRIPTION OF THE DRAWINGS

FIG. 1 is a block diagram showing the galvanizing process of the present invention, in accordance with a preferred embodiment.

FIG. 2 is a diagram showing a group of rebar sticks on the conveyor, moving along the path through the galvanizing process.

FIG. 3 is a view of an end portion of a driven roller.

FIG. 4 is a block diagram showing the cleaning stage.

FIG. 5 shows the flux treatment stage.

FIG. 6 shows the interior of the galvanizer stage in a side view.

FIG. 7 shows the exterior of the galvanizer stage in an end view.

FIG. 8 is an end view of a retention mechanism for bundling the rebar.

### DESCRIPTION OF THE PREFERRED EMBODIMENT

Elongated articles are protected from corrosion in a low cost manner by continuous galvanizing. The articles are moved continuously along a line that passes through the various stages of galvanizing. The speed of movement along the line, the dwell times of the articles at each stage of processing, the temperatures used in the various stages, and other process parameters, combine to provide fast, high quality galvanizing in a low cost manner. Also, the articles travel parallel to one another in each stage so as to further increase throughput.

The articles are galvanized with a galvanizing bath that is zinc based, with some aluminum. The provision of aluminum in the galvanizing bath adds flexibility to the galvanized coating. For example, if a length of galvanized rebar is bent, the galvanized coating allows such flexing and does not flake or chip. Although aluminum is beneficial to allowing flexibility of the rebar, the provision of aluminum increases the difficulty of the galvanization process. Aluminum content in the galvanizing bath increases the likelihood of dross formation. Yet, the process described herein minimizes the formation of dross in the galvanizing stage, leading to a higher utilization of zinc, less waste and less downtime.

Although the description herein refers to rebar, the process can be used on other articles as well, such as T-posts (for fencing), rods, round stock, angles, sign posts, etc. Rebar comes in various sizes. For example, rebar typically ranges from ⅜ inch diameter (#3 rebar) to 1⅜ inches diameter (#11 rebar).

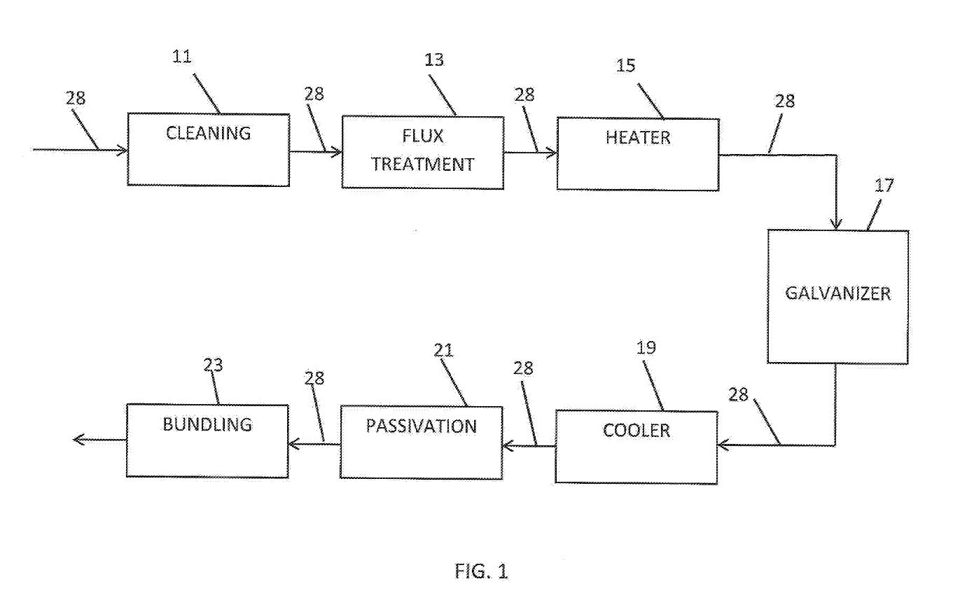

Referring to FIG. 1, the galvanizing process in general moves groups of rebar through various stages. The first stage 11 is cleaning. As the rebar comes into the galvanizing plant, it typically contains rust, scale and other contaminants. These are removed during cleaning. The rebar then enters a flux treatment stage 13, which further cleans and prepares the rebar for galvanizing. Next, the rebar moves through a heater stage 15 where it is brought up to a suitable temperature. Then the rebar enters the galvanizing stage 17, where the galvanizing material is brought into contact with the rebar. The galvanizing is done in a nitrogen environment to minimize oxidation of the hot galvanizing material. The galvanized rebar passes through a cooler stage 19 to reduce the temperature and then to an optional passivation stage 21 where a coating is applied to the galvanizing to minimize corrosion. From there, the rebar moves to a bundling stage 23 for shipment.

In the description, like reference numbers throughout the drawings indicate like components.

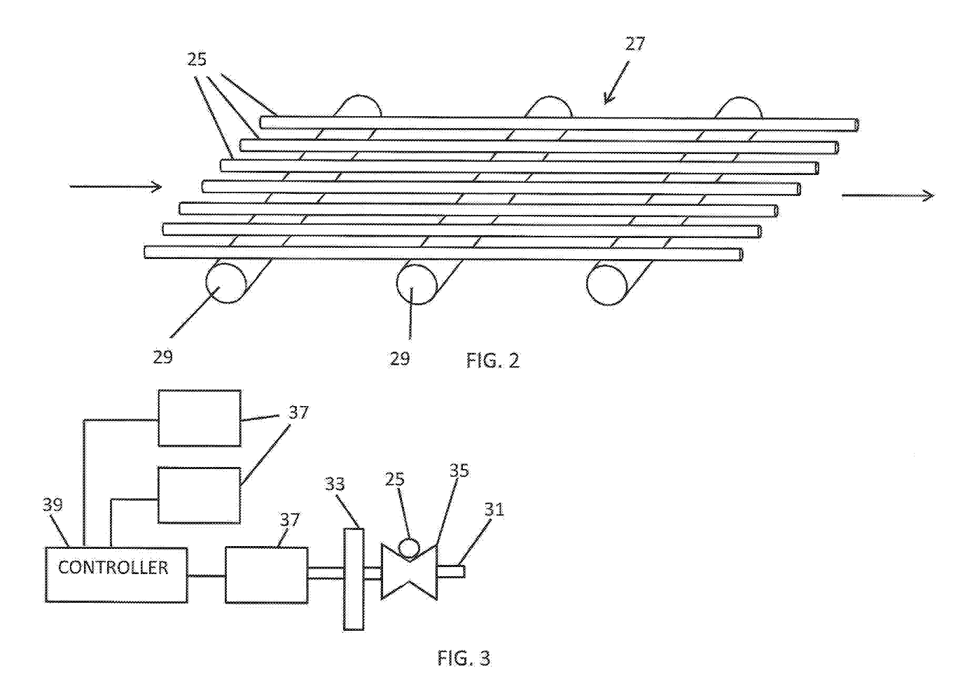

Referring to FIG. 2, the rebar 25 is in sticks or lengths. A typical stick is 20, 40 or 60 feet long. A number of sticks 25 are arranged side by side to make up a group 27 of rebar. For example, there may be five or more sticks in a group. The sticks in a group travel together along a path through the stages 11-23. The sticks in a group are parallel to one another. Preferably, the sticks in a group are of the same length. One group follows another group through the stages. There is a gap between the sticks in one group and the sticks in the adjoining groups.

As the rebar moves along the path, it moves in a downstream direction. The cleaning stage 11 is upstream from the flux treatment stage 13, which in turn is upstream from the heater stage 15, and so on.

The sticks 25 of rebar are moved along the path by way of a conveyor 28. In the preferred embodiment, the conveyor is a series of rollers 29 spaced apart along the path (FIG. 2 shows the rollers schematically). Each roller has a shaft 31 that is mounted between two side frames 33 (see FIG. 3 which shows one frame and one roller member). The frames extend along the path. Each roller 29 has plural roller members 35 located along the shaft. Each roller member 35 has a trough for receiving an individual stick of rebar 25. The roller members 35 maintain lateral spacing between the individual sticks of rebar in a group.

The rollers may be driven or idler rollers. A driven roller has a drive motor 37 to drive the respective shaft and the associated roller members. An idler roller is not driven, but instead the roller members rotate freely when rebar moves in contact with the roller members. A controller 39 is provided to control the speeds of the drive motors 37 so as to achieve a constant speed of the moving rebar along the path.

There is a conveyor 28 before the cleaning stage 11, between the cleaning and flux treatment stages 11, 13, in the flux treatment stage 13, between the flux treatment stage 13 and the heater stage 15, between the heater and galvanizer stages 15, 17, between the galvanizer and cooler stages 17, 19, in the cooler stage 19, between the cooler stage 19 and the passivation stage 21, in the passivation stage and between the passivation stage and the bundling stage 23. The conveyor 28 is not continuous along the path and in fact has gaps therein. One such gap is in the cleaning stage. Other such gaps include the heater stage and the galvanizer stage. Thus, the conveyor is in sections. Each section has a drive motor and a driven roller, as well as idler rollers. Idler rollers may be located in a stage, such as the passivation stage.

The conveyor rollers all operate to convey the sticks of rebar in an individual group at the same speed. In addition, the conveyors operate to convey the groups at the same speed between stages. For example, the rebar moving through the cleaning stage travels at the same speed as the rebar moving through the galvanizing stage.

Because the sticks of rebar are long, individual sticks of rebar in a group may be partially located in a particular stage at any given time. For example, as a group of sticks enters the cleaning stage 11, the upstream portion of the group is located outside of the cleaning stage. As the group of sticks continues to move along the path, the downstream end of the group exits the cleaning stage and an intermediate portion of the group is located inside of the cleaning stage, while the upstream end is located outside of the cleaning stage. As the group continues to move downstream, the downstream and intermediate portions are outside of the cleaning stage and the upstream portion is inside of the cleaning stage.

The speed of the rebar on the path is 19-57 feet per minute. The speed depends on the size of the rebar undergoing galvanizing. In general, smaller diameter rebar moves at a faster speed along the path than does larger diameter rebar. Larger diameter rebar takes longer to heat in the heater stage 15. For example, #3-#7 rebar moves at 27-57 feet per minute, while #8-#9 rebar moves at the slower speed of 21-35 feet per minute. #10 and #11 rebar moves at the slowest speed of 19-27 feet per minute. When compared to other galvanizing processes, these speeds are very fast.

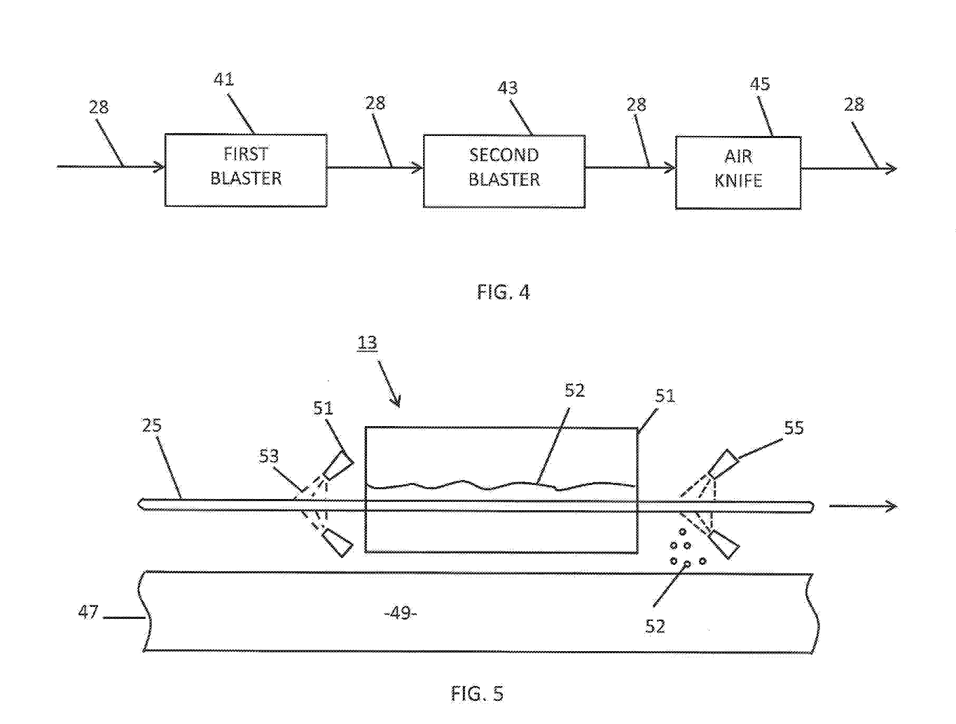

The group of rebar sticks initially enters the cleaning stage 11, where the rebar is cleaned of organic contaminants, such as grease, oil and dirt, as well as scale and rust. In addition, the rebar may be contaminated with epoxy, vinyls, asphalt or welding slag. These are also removed by the cleaning stage. The cleaning stage also prepares the surface of the rebar for galvanizing by roughening the surface. Referring to FIG. 4, the cleaning stage has a first blaster 41 and a second blaster 43. In each blaster, cleaning media is directed under pressure against the rebar sticks. Each blaster has a housing located around an interior space. The housing has an upstream entry and a downstream exit. A portion of a group of rebar sticks enters the housing at the upstream entry. In the interior space of the housing, nozzles direct cleaning media at the sticks of rebar. There are provided upper nozzles and lower nozzles, with the path and the sticks of rebar located between the upper and lower nozzles. The nozzles direct the cleaning media at various angles to the rebar so as to contact all of the surfaces around the circumference of the rebar. The spent cleaning media collects at the bottom of the housing and is reused.

The cleaning media used in the blasters is steel shot and grit. Shot has individual particles that are spherical. Grit has more angular particles. The shot and grit can be a single size or plural sizes. For example, in the preferred embodiment, the shot and grit is a mixture of a larger size and a smaller size. Both sizes of shot and grit serve to remove contaminates from the rebar. The large size shot and grit also pits the surface of the rebar. The pits are irregular in spacing and relatively deep into the surface of the rebar. The pitting process leaves peaks between the pits. Typical sizes of the cleaning media are 250-500 microns.

The sticks of rebar in a group exit the cleaning stage and pass through an air knife 45 before entering the flux treatment stage 13. The air knife uses compressed air and removes any loose material on the rebar from the cleaning process. The air knife has nozzles located adjacent to the rebar on the conveyor.

The rebar is conveyed to the flux treatment stage 13 (FIG. 5). Fluxing removes any remaining oxides from the steel and prevents additional oxides from forming before the rebar is galvanized. The flux treatment stage has an elongated vat with flux. The flux is pumped from the main vat 49 into a raised vat 51 in which the bars pass through a bath of flux 52. The flux bath is maintained deep enough so that bars are submerged in the bath as it passes through. The flux is typically zinc ammonium chloride. The flux temperature is ambient and the volume of the pump is 60-120 gpm. Excess flux 52 drips back into the vat 51. A pump (not shown) moves flu from the vat 47 to the raised vat 51.

Excess flux on the rebar compromises obtaining a satisfactory galvanization. An air knife 55 located at the exit removes excess flux 52 from the rebar. The air knife uses compressed air blown through nozzles onto the wet rebar. The moving air impacts the wetted rebar and blows excess flux off the rebar. The blown flux falls into the vat. The rebar sticks exit the flux treatment stage. A hood or housing over the vat and the nozzles contains the flux. The hood has an entry and an exit for the rebar.

After fluxing, the rebar enters the heater stage 15. The heater dries the flux on the rebar and quickly raises the temperature of the rebar. In a typical galvanizing process, the steel part is dipped into the molten bath of zinc and held there for some period of time. The molten zinc heats the steel part to the desired temperature. With the heater, the rebar is brought up to a hotter temperature before entering the galvanizer stage. This minimizes the time needed to heat the rebar in the galvanizing stage. The rebar enters the heater stage at ambient temperature and exits the heater at 250-450 degrees F.

The heater uses induction heating for rapid and high heating. The induction heating can occur in one or more stages. The rebar sticks travel through coils of wire. Electrical current flows through the wire coils to inductively heat the rebar.

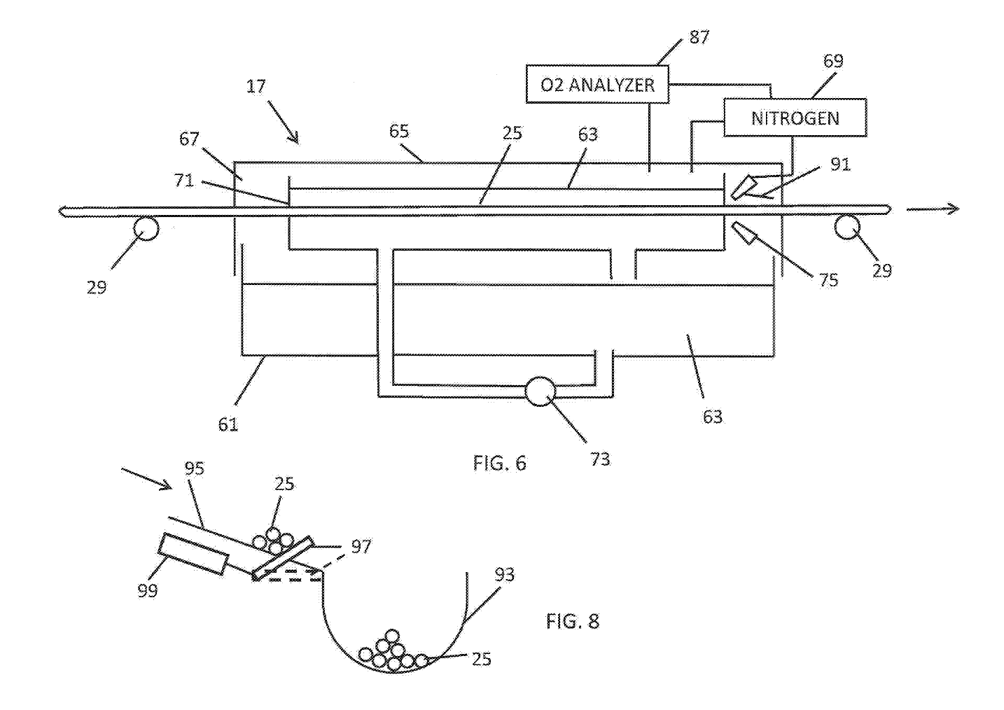

The rebar exits the heater and enters the galvanizer stage 17 (see FIG. 6). The galvanizer stage has a kettle 61 with the molten galvanizing bath 63. The galvanizing bath comprises zinc, with a small amount of aluminum. The amount of aluminum is 0.1-1.0% by weight. The temperature of the galvanizing bath is 835-880 degrees F.

A galvanizing bath with aluminum content is susceptible to oxidation when exposed to the atmosphere and in particular to oxygen. To minimize exposure, a gas envelope 67 is provided inside the galvanizing stage and in contact with the surface of the galvanizing bath 63. A hood 65 forms an enclosure for the gas envelope. The gas is inert to the galvanizing bath and in the preferred embodiment, is nitrogen. A nitrogen source 69 provides the nitrogen under pressure to the hooded enclosure. The hood has an entry and an exit for the sticks of rebar 25. The hood is insulated 66 and sealed to minimize escape of the gas. However, a small amount of gas escapes through the entry and exit rebar openings in the hood. The use of pressurized nitrogen provides an overpressure inside the hood so as to minimize the entry of oxygen.

In spite of the seals and overpressure of nitrogen, some oxygen may enter the hood enclosure through the openings for the rebar. Thus, the gas inside the hood may contact small quantities of oxygen. The galvanizing bath, with its aluminum content, is susceptible to reacting with even small amounts of oxygen and, producing a foamy material that must be removed from the galvanizer. Removal can be difficult and expensive. The use of the trough 71, submerging the rebar in the bath, and nitrogen minimizes the production of the foamy material.

Located above the kettle is an elongated trough 71. The ends of the trough have openings for the rebar to pass through. The rebar enters the trough at one end and exits at the opposite end. A pump system 73 circulates the galvanizing bath 63 from the kettle 61 to the trough 71. The galvanizing bath in the trough 71 is maintained at a level deep enough to submerge the rebar passing through the trough. The pump system 73 takes the galvanizing bath from the kettle and pumps the bath metal into the bottom of the trough. This minimites surface area contact of the bath with the gas inside the hood.

The rebar dwells or remains inside of the galvanizing bath in the trough 71 for a sufficient period of time to obtain a satisfactory galvanization. The dwell times of the rebar in the trough depends on the size of the rebar, with the larger size rebar spending more time inside the trough than smaller size rebar. In the preferred embodiment, #3-7 rebar dwells 10-20 seconds in the galvanizing bath. Each point on the surface of the rebar is thus in contact with the galvanizing bath for 10-20 seconds. In one embodiment, the dwell time for this size rebar is 12-19 seconds. In the preferred embodiment, #8 and 9 rebar dwells 15-26 seconds in the galvanizing bath. In one embodiment, the dwell time for #8 rebar is 17-20 seconds, while the dwell time for #9 rebar is 20-26 seconds. In the preferred embodiment, #10 and #11 rebar dwells 20-29 seconds in the galvanizing bath. In one embodiment, the dwell time for #10 and #11 rebar is 24-28 seconds. These speeds are fast and lead to high productivity of the overall process.

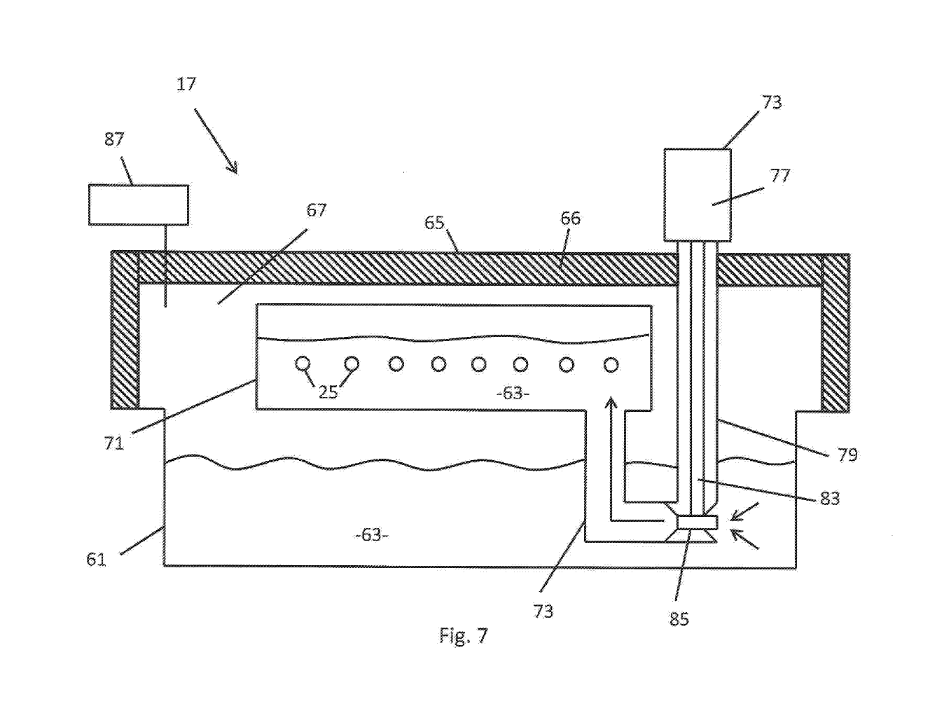

FIG. 7 shows the pump system 73 as having a pump 77 located above the hood 65. A riser 79 extends through the hood and into the bath 63. The riser connects to a sump 81 that connects to the bottom of the trough 71. A shaft 83 is located in the riser, connecting the pump to an impeller 85. As the pump rotates the impeller 85, galvanizing bath 63 is taken from the kettle 61 and pumped into the bottom of the trough 71. Thus, there is no vertical separation of the galvanizing bath 63 in the trough 71 and the galvanizing bath in the kettle 61. An oxygen analyzer 87 (FIG. 6) senses and analyzes the oxygen content in parts per million inside the hood 65. If the amount of oxygen increase, the analyzer causes more nitrogen to be input into the hood by the nitrogen source 69.

As the rebar exits the hood, air knives 75 blow excess galvanizing from the rebar. The knives use compressed, heated nitrogen. Typical pressures are 2-15 psi. Once the rebar leaves the nitrogen knife there is a final knife that uses compressed air to complete the wiping process. A knife cover 91, which is a hinged plate, is provided to move between an up position and a down position. In the down position, which is when no rebar is present, the openings of the knives are covered, further minimizing oxygen intrusion into the hood. In FIG. 6, the cover 91 is shown in the up position.

After exiting the galvanizing hood, the rebar enters the cooler stage 19 where it is quickly cooled to 120 degrees Fahrenheit or cooler. The rebar travels through one or more troughs of water so as to be in contact with cooled water in the cooler stage. The water is circulated in the trough counterflow to the direction of travel of the rebar. The water circulates to a chiller heat exchanger, where it is cooled and returned to the stage.

The cooled galvanized rebar moves to the passivation stage 21. The passivation solution such as trivalent chromium is maintained deep enough so that bars are submerged in the bath as it passes through. The passivation of rebar prevents further corrosion thereof.

The passivation stage is optional. For some articles, particularly those undergoing a second coating, passivation is not used. A second coating may be an epoxy coating or a plastic coating. Passivation may interfere with the boding of the second coating. When passivation is not needed, the nozzles do not spray a passivation solution.

In the event of a duplex system, painting over galvanizing, the rebar will skip the passivation process. The tank will be emptied allowing the bar the pass through unpassivated.

From the passivation stage, the sticks of rebar move to the bundling stage 23 where they are bundled and prepared for shipment. FIG. 8 is an end view of a retention mechanism for bundling the rebar. A “U” shaped member 93 is provided under a ramp 95. The bundling stage has several members 93 and ramps 95 spaced longitudinally so as to support the lengths of rebar. A group of rebar 25 falls from the ramp 95 into the “U” shaped member 93 where, when the desired quantity is achieved, it is bundled together and bound as a bundle. Because the process is continuous, in order to prevent the next group of rebar from adding the group being bundled, each ramp has a kick trip arm 97. The arm 97 pivots from a down position (shown by dashed lines) where rebar can exit the ramp 95 and fall into the member 93, and an up position (shown by solid lines) where the rebar is stopped on the ramp. A hydraulic cylinder 99 actuates the arm 97. The arms 97 on each ramp 95 operate in unison.

It should be known to those skilled in the art that the foregoing disclosure and showings made in the drawings are merely illustrative of the principles of this invention and are not to be interpreted in a limiting sense.

1. A method of continuously galvanizing elongated articles, comprising the steps of:
a) conveying a plurality of the elongated articles side by side in a group through a cleaning stage to remove contaminants and blasting the elongated articles with cleaning media;
b) conveying the group of elongated articles through a flux stage and spraying flux on the elongated articles;
c) removing excess flux from the group of elongated articles;
d) heating the fluxed group of elongated articles;
e) providing a kettle with a galvanizing bath comprising zinc and aluminum, the aluminum comprising 0.1-1.0% by weight and heating the galvanizing bath in the kettle;
f) circulating the galvanizing bath from the kettle into a bottom of a trough;
g) conveying the group of heated elongated articles through the galvanizing bath in the trough and removing excess galvanizing material from the group of elongated articles;
i) cooling the group of galvanized elongated articles.

2. The method of continuously galvanizing elongated articles of claim 1, wherein the steps of conveying the group of elongated articles through the cleaning stage, the flux stage and the galvanizing bath further comprises the steps of using grooved rollers to maintain a fixed spacing between the side by side elongated articles.

3. The method of continuously galvanizing elongated articles of claim 1, wherein the step of blasting the elongated articles with cleaning media further comprises the steps of using a first size media and a second size media, the first size media being larger than the second size media.

4. The method of continuously galvanizing elongated articles of claim 3, wherein the step of blasting comprises a first blasting with the first size media, followed by a second blasting with the second size media.

5. The method of continuously galvanizing elongated articles of claim 1, wherein the steps of conveying the group of elongated articles through the cleaning stage, the flux stage and the galvanizing bath further comprises the steps of maintaining a constant speed of the group of elongated articles.

6. The method of continuously galvanizing elongated articles of claim 1, wherein the elongated articles comprise sticks of reinforcing bar.

7. The method of continuously galvanizing elongated articles of claim 6, wherein the group of reinforcing bars is conveyed at speeds of 20-50 feet per minute.

8. The method of continuously galvanizing elongated articles of claim 6, wherein the group of reinforcing bars is conveyed at speeds of 35-50 feet per minute.

9. The method of continuously galvanizing elongated articles of claim 1 wherein the step of circulating the galvanizing bath from the kettle into a bottom of the trough further comprises the step of circulating the galvanizing bath into a sump of the trough.

10. The method of continuously galvanizing elongated articles of claim 1, further comprising the step of providing a nitrogen atmosphere around the trough.

11. The method of continuously galvanizing elongated articles of claim 1, further comprising the step of controlling the movement of groups of the elongated articles into a bundling area.
